(19) United States
(12) Patent Application Publication
(10) Pub. No.: US 2011/0264958 A1
(43) Pub. Date: Oct. 27, 2011

(54) TEST FRAMEWORK FOR A NOTEBOOK COMPUTER

(75) Inventor: CHIA-HUNG HSU, Taipei (TW)

(73) Assignee: INVENTEC CORPORATION, Taipei (TW)

(21) Appl. No.: 12/967,905

(22) Filed: Dec. 14, 2010

(30) Foreign Application Priority Data
Apr. 23, 2010 (TW) 099112799

(51) Int. Cl. G06F 11/07

(52) U.S. Cl. 714/34; 714/E11.025

(57) ABSTRACT

The disclosed simplified test framework comprises a first module substituting the mobile network module of the computer to communicate with a mobile phone network, configured with signal pins of VCC connected to a voltage of +3V, RST, VPP, CLK, and DATA while enabling the VCC to power source; and a second module substituting the subscriber identity module of the computer to identify a subscriber's identity on the computer, configured with signal pins of VCC, GND, RST, VPP, CLK, and DATA; wherein the VCC, RST, CLK, and DATA of the first module is connected to those of the second module, respectively, a light emitting diode connects the VCC and RST of the second module, the RST and CLK of the first module are connected to each other, an impedance connects the CLK and DATA of the second module, and the DATA is connected to an electric ground.

### TECHNICAL FIELD

The present disclosure relates to a test framework for a notebook computer, and more particularly, to a test framework for substituting the mobile network card and SIM (subscriber identity module) card in testing a mobile network module and a subscriber identity module of a notebook computer.

### TECHNICAL BACKGROUND

A notebook or laptop computer is developed for portability, so it is more compact than a desktop computer. At the present days, most of the notebook computers are equipped with two mini PCI slots, one for the wireless local area network (WLAN) and the other for the 3G wireless network. To access the 3G wireless network via a mobile phone system, a notebook computer needs to be further equipped with a SIM card slot. Referring to FIGS. 1A and 1B, schematic diagrams of conventional mobile network card and SIM card of a notebook computer are respectively shown. To test a mobile network module and a subscriber identity module of a computer in the practical test process, one needs to plug the two cards respectively into the corresponding mini PCI and SIM card slots. Besides, a mobile network card usually costs a lot and tends to be damaged after being plugged repeatedly.

### TECHNICAL SUMMARY

It is therefore a main object of the present invention is to provide a simplified test framework for a notebook computer to substitute a mobile network card and a SIM card when the mobile network module and subscriber identity module of a notebook computer are tested.

It is another object of the present invention is to avoid damage of a mobile network card after being plugged in and out repeatedly

These objects are achieved, in one aspect of the invention, by provision of a test framework comprising a first module substituting the mobile network card for the computer to communicate with a mobile phone network, configured with a VCC signal pin connected to an electric voltage of +3V, an RST signal pin, a VPP signal pin, a CLK signal pin, and a DATA signal pin while enabling the VCC signal pin to power source; and a second module substituting the SIM card on the computer, configured with a VCC signal pin, a GND signal pin, an RST signal pin, a VPP signal pin, a CLK signal pin, and a DATA signal pin; wherein the VCC signal pin of the first module is connected to the VCC signal pin of the second module, a light emitting diode connects the VCC and the RST signal pins of the second module, the RST signal pin of the second module is connected to the RST signal pin of the first module, the RST and the CLK signal pins of the first module are connected to each other, the CLK signal pin of the first module is connected to the CLK signal pin of the second module, an impedance connects the CLK and the DATA signal pins of the second module, the DATA signal pin of the second module is connected to the DATA signal pin of the first module, and the DATA signal pin is connected to an electric ground.

Preferably, the impedance is composed of a resistance.

Preferably, the first module further comprises a USB interface

Preferably, the first module further comprises a mini PCI interface slot.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIGS. 1A and 1B show schematic diagrams of conventional mobile network card and SIM card of a notebook computer, respectively.

FIG. 2A shows schematically a first module card 2, substituting the mobile network card according to an embodiment of the present invention.

FIG. 2B shows schematically a second module card 3, substituting the SIM card according to another embodiment of the present invention.

FIG. 3 shows schematically a pin diagram of the IC mounted on the first module.

FIG. 4 is a circuit diagram of the first module and the second module according to the embodiment.

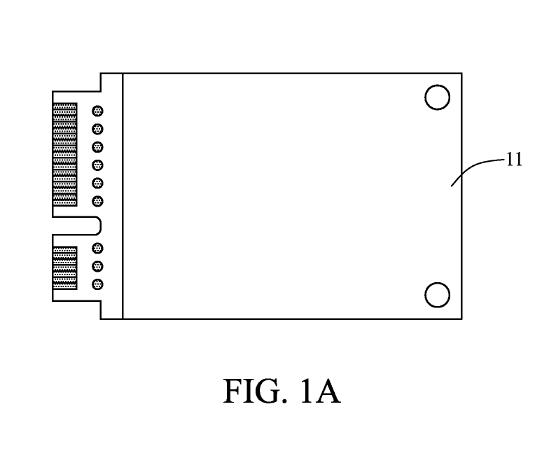

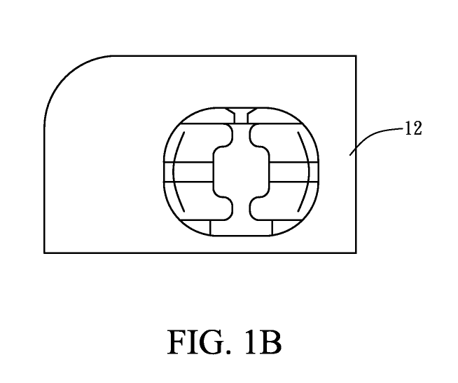

### DESCRIPTION OF THE EXEMPLARY EMBODIMENTS

For further understanding the fulfilled functions and structural characteristics of the disclosure, exemplary embodiments cooperating with detailed description are presented as the follows.

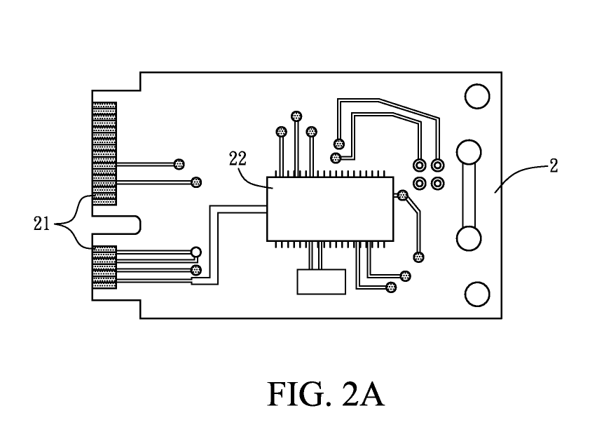

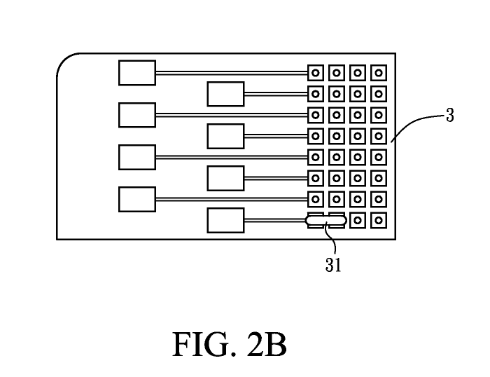

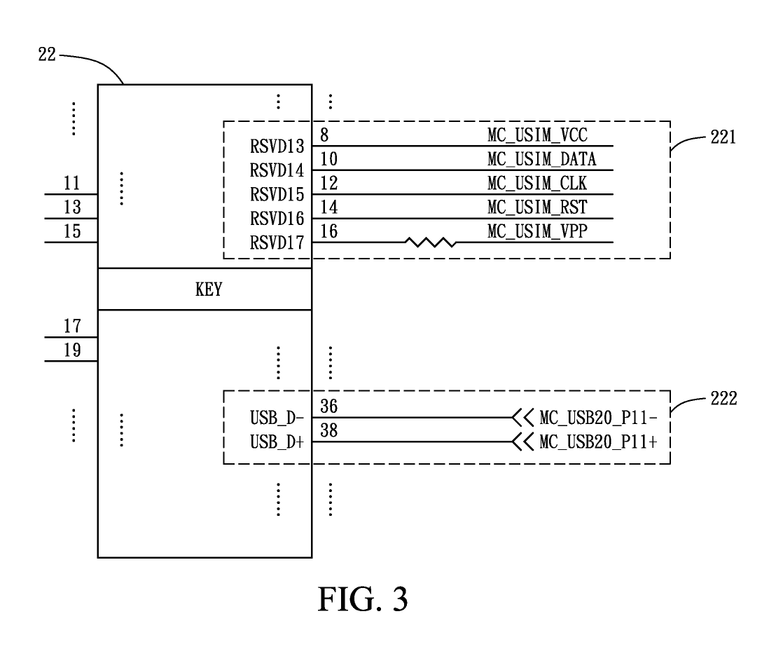

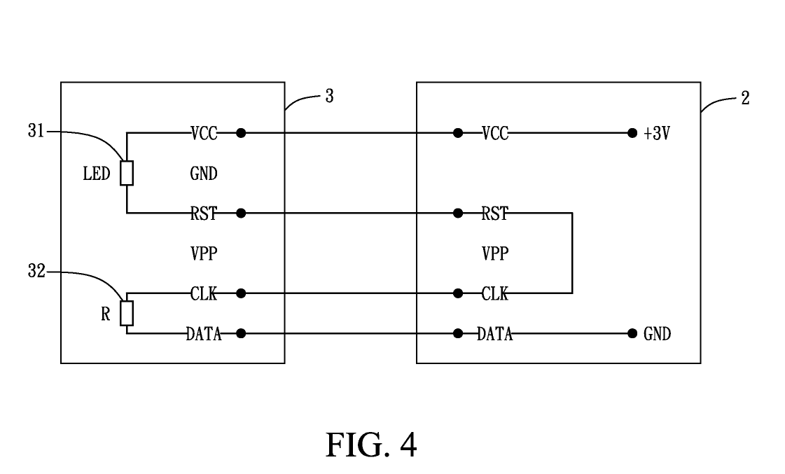

Please refer to FIG. 2A, FIG. 2B, and FIG. 3. FIG. 2A schematically shows a first module card 2, substituting the mobile network card according to an embodiment of the present invention. FIG. 2B schematically shows a second module card 3, substituting the SIM card according to another embodiment of the present invention. FIG. 3 schematically shows a pin diagram of the IC (integrated circuit) 22 mounted on the first module 2. The embodiment comprises: a first module 2 substituting the mobile network card for the computer to communicate with a mobile phone network, configured with signal pins VCC (power) connected to an electric voltage of +3V, RST (reset), VPP (power), CLK (clock), DATA (data) 221, and USB (for USB connection) 222; and a second module substituting the SIM card to identify a subscriber's identity on the computer, configured with signal pins VCC (power), GND (ground), RST (reset), VPP (power), CLK (clock), and DATA (data), not shown in the figures. Please further refer to FIG. 4, wherein the VCC signal pin of the first module is connected to the VCC signal pin of the second module, a light emitting diode 31 connects the VCC and the RST signal pins of the second module, the RST signal pin of the second module is connected to the RST signal pin of the first module, the RST and the CLK signal pins of the first module are connected to each other, the CLK signal pin of the first module is connected to the CLK signal pin of the second module, an impedance 32 connects the CLK and the DATA signal pins of the second module, the DATA signal pin of the second module is connected to the DATA signal pin of the first module, and the DATA signal pin is connected to an electric ground. In an exemplary embodiment, the impedance 32 is composed of a resistance.

With regard to the 3G mobile network card, it can be configured with a USB interface, and mainly contains the following signals: USB_D−, USB_D+, USIM_VCC, USIM_DATA, USIM_CLK, USIM_RST, and USIM_VPP. The embodiment constructs a test framework or a substitute card of a mini PCI interface having contacts for the foregoing signals, wherein the forgoing signals are provided by the substitute card rather than by a substantial mobile network card. Consequently, the test framework according to the embodiment has cost advantages.

In the embodiment, USB_D− and USB_D+ of the USB signal 222 are connected to the mini PCI slot 21 and the SIM Card slot. The signal pins of the second module card 3 are connected to the corresponding signal pins of the first module card 2 and, finally, to be strung to be a circuit loop, wherein a light emitting diode 31 is used as an indicator to show the testing result for the test operators. The first module card 2 further comprises a USB interface with data signals USB_D− and USB_D+ and a USB IC to communicate with the computer host.

The above description of the embodiments according to the present invention indicates the operational mechanism of a test framework to substitute a mobile network card and a SIM card when the mobile network module and subscriber identity module of a notebook computer are tested. By using the test framework, repeatedly plugging in and out of the genuine cards can be avoided. Moreover, the light emitting diode 31 and the resistance 32 are conducive to simplify the test process of a notebook computer.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A test framework for a notebook computer, to concurrently test a mobile network module and a subscriber identity module of the computer, comprising
a first module substituting the mobile network card for the computer to communicate with a mobile phone network, configured with a VCC signal pin connected to an electric voltage of +3V, an RST signal pin, a VPP signal pin, a CLK signal pin, and a DATA signal pin while enabling the VCC signal pin to power source; and
a second module substituting the subscriber identity card for the computer to identify a subscriber's identity on the computer, configured with a VCC signal pin, a GND signal pin, an RST signal pin, a VPP signal pin, a CLK signal pin, and a DATA signal pin;
wherein the VCC signal pin of the first module is connected to the VCC signal pin of the second module, a light emitting diode connects the VCC and the RST signal pins of the second module, the RST signal pin of the second module is connected to the RST signal pin of the first module, the RST and the CLK signal pins of the first module are connected to each other, the CLK signal pin of the first module is connected to the CLK signal pin of the second module, an impedance connects the CLK and the DATA signal pins of the second module, the DATA signal pin of the second module is connected to the DATA signal pin of the first module, and the DATA signal pin is connected to an electric ground.

2. The simplified testing framework of claim 1, wherein the impedance is composed of a resistance.

3. The simplified testing framework of claim 1, wherein the first module further comprises a USB interface.

4. The simplified testing framework of claim 1, wherein the first module further comprises a mini PCI interface slot.
